(19) United States
(12) Patent Application Publication
(10) Pub. No.: US 2007/0124975 A1
(43) Pub. Date: Jun. 7, 2007

(54) System for properly orienting and coordinating clothing

(76) Inventor: Rima Kasprzak, Pleasant Hill, CA (US)

Correspondence Address: WEST & ASSOCIATES, A PC, 2815 MITCHELL DRIVE, SUITE 209, WALNUT CREEK, CA, 94598, US

(21) Appl. No.: 11/296,121

(22) Filed: Dec. 6, 2005

(51) Int. Cl. G09F 3/18

(52) U.S. Cl. 40/661.04

(57) ABSTRACT

A system for assisting children and adults with properly dressing themselves with respect to clothing orientation and coordination. Visual and tactile indicators correspond to spatial orientation and aesthetic coordinations. By noting the indicators, people can properly orient clothing on themselves and select coordinating clothing ensembles.

### CLAIM OF PRIORITY

This application claims priority under 35 USC §119(e) from U.S. Provisional Application Ser. No. ______, filed Dec. 7, 2004, the entirety of which is incorporated herein by reference.

### BACKGROUND

1. Field of the Invention

The present disclosure is for a device that assists children and adults in properly putting on and matching clothing.

2. Background

Although most adults take it for granted, learning to dress themselves is a milestone for small children. Many children have difficulty comprehending orientation concepts such as “right” versus “left”,“front” versus “back”,and “inside” versus “outside”. This can present a problem when they try to dress themselves and end up wearing their clothes backwards or inside out, which can be frustrating for them. Further, children may also have trouble coordinating colors and patterns.

Some adults, however, may also have difficulties in dressing themselves due to disabilities or other issues. A developmentally delayed adult may also have problems understanding how to properly orient clothing. A color-blind person may be able to put on the clothing properly, but may not be able to coordinate certain colors, such as red and green, and end up wearing an outfit with clashing colors. Although visually impaired persons usually learn to properly orient their clothing by feel, they may need assistance with coordinating colors and patterns. Finally, even adults without any disabilities can lack fashion sense and fail to properly coordinate their clothing ensembles.

What is needed is a system that assists persons in properly orienting and coordinating their clothing. For children, it should be especially visually interesting, with entertaining characters and fun colors, so that they will be inclined to use it. For both adults and children, it should be easy to use and not interfere with the clothing itself.

### BRIEF DESCRIPTION OF THE DRAWINGS

FIG. 1 depicts an embodiment of the present system, showing an embodiment of the “front” visual orientation indicators.

FIG. 2 depicts an embodiment of the present system, showing another embodiment of the “back” visual orientation indicators.

FIG. 2a depicts the embodiment of the “front” visual orientation indicator in use on the inside of a conventional shirt.

FIG. 3 depicts an embodiment of the present system, showing another embodiment of the “right/left” visual orientation indicators.

FIG. 4 depicts an embodiment of the present system, showing another embodiment of the “right/left” visual orientation indicators.

FIG. 5 depicts and embodiment of the present system, showing an embodiment of the “right/left” visual orientation indicators used together.

FIG. 5a depicts the “right/left” visual orientation indicators in use in a conventional pair of shoes.

FIG. 6 depicts and embodiment of the present system, showing an embodiment of the visual coordination indicators.

FIG. 6a depicts the embodiment of the visual coordination indicators in use on two coordinating articles of clothing.

FIG. 7 depicts the embodiment of the present system, showing an embodiment of the tactile coordination indicators.

### DETAILED DESCRIPTION

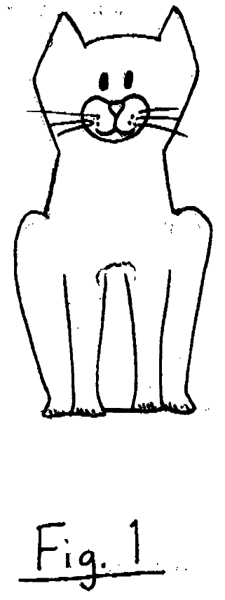

FIG. 1 depicts an embodiment of the present system. In this embodiment, a substantially planar surface having a visual orientation indicator taking the form of an animal or cartoon image. Here, the image is a front view of an animal. An animal image would be particularly attractive to children and encourage them to use the system. Further, they could benefit from the system even of they can't read. However, the image may also be of a human form or other creature, symbolic image, or be text (e.g., “front”) for children that can read. The indicator may be made of a textile, polymer, or any other material known or convenient. It is affixed to an article of clothing by an adhesive, appliqué, hook-and-loop patch, thermosetting adhesive, thread, Velcro®, or any other means known or convenient.

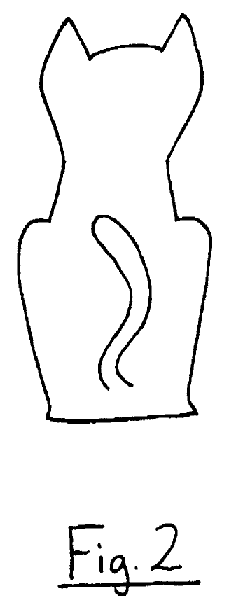

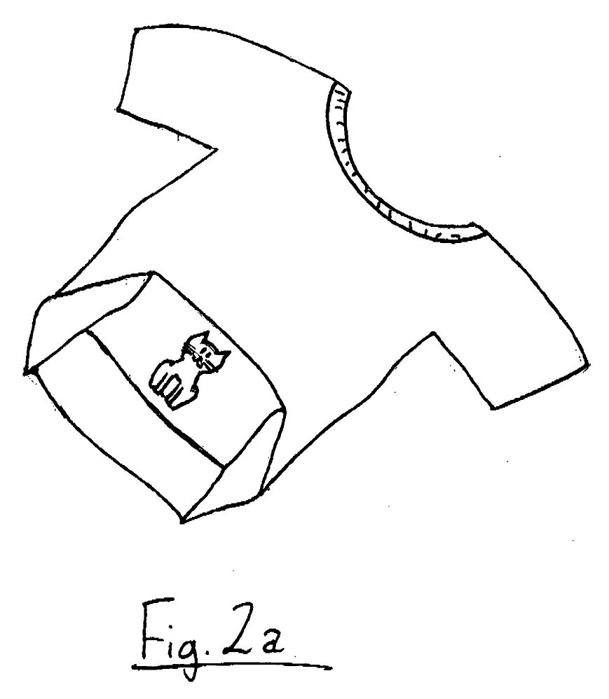

FIG. 2 depicts another embodiment of the present system, wherein the image on the planar surface is a back view of an animal.

FIG. 2a depicts a perspective view of an embodiment of the present system, wherein the “front” animal image embodiment is affixed to the inside of a conventional shirt. To use the visual indicators to properly orient clothing, the substantially planar surface of the indicators would be affixed to the corresponding area of an article of clothing. For example, the indicator for “front”, as shown in FIG. 2a, would be affixed somewhere on the front of a shirt or pair of pants. In one embodiment, the indicator surface would be positioned on the inside of the garment so that it would not be seen from the outside. However, it could be positioned on the outside if desired. Positioning it on the inside, though, assists a person with determining the “inside” and “outside” of pieces of clothing. Likewise, the indicator depicting “back” would be affixed to the back portion of the garment. As the person puts on the clothing, he looks at the indicator and “matches” it such that it faces his own corresponding body area. For example, the frontal view matches the person's front, and the back view matches the person's back.

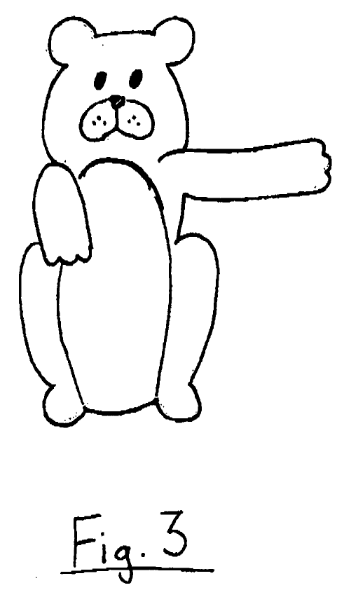

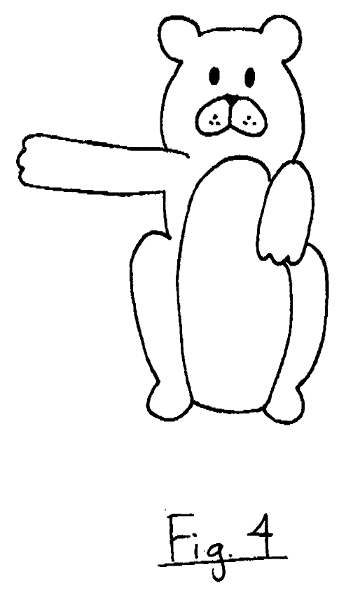

FIG. 3 depicts another embodiment of the present system, wherein the indicators correspond to “right” and “left” orientations. FIG. 4 depicts the mirror image of the indicator in FIG. 3. In this embodiment, each animal image has one limb extended to one side. Although an animal is depicted here, the image could be a human figure or other creature, symbolic image, or text (e.g.,“right” or “R”) for children that can read. In alternate embodiments, the figures can be other than mirror images.

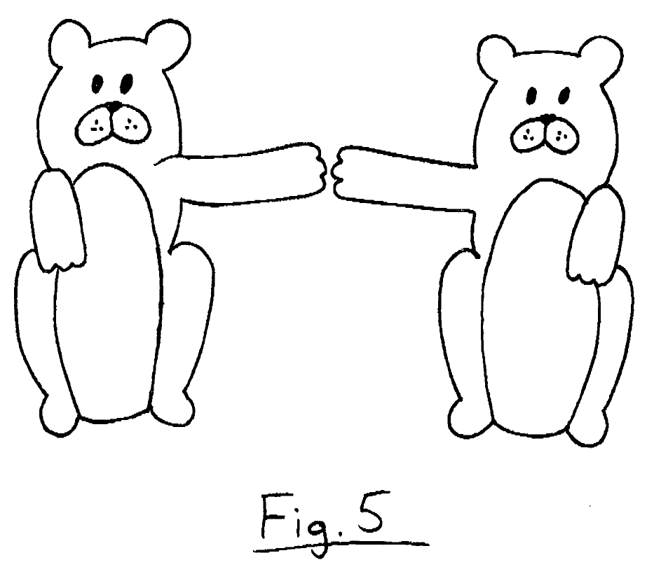

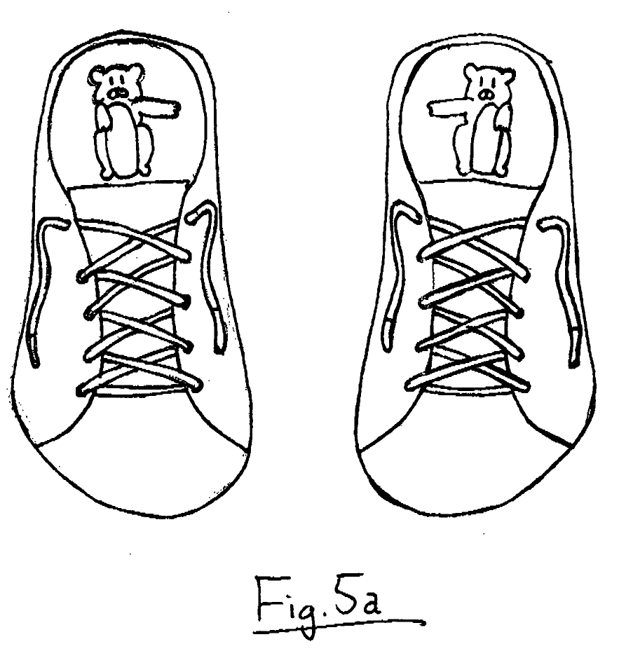

FIG. 5 depicts the two embodiments together with the images aligned such that the opposite “arms” are extended toward one another. In this embodiment, the two images together form a set to properly orient two articles that make up a pair, such as, but not limited to, shoes or gloves.

FIG. 5a depicts this embodiment in use in a conventional pair of shoes. The images are affixed in the right and left shoes such that the animals' outstretched “arms” reach toward each other as if to “hold hands” when the shoes are lined up properly with the person's correct feet. Again, although animals are shown in this embodiment, other embodiments can use human symbols or text indicating “right” or “left”.

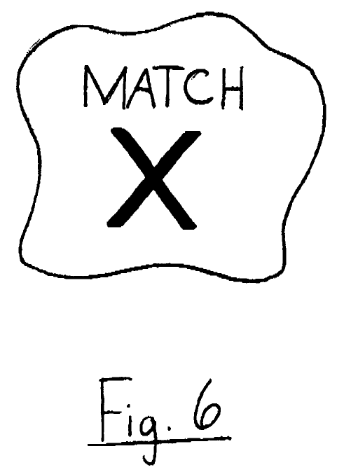

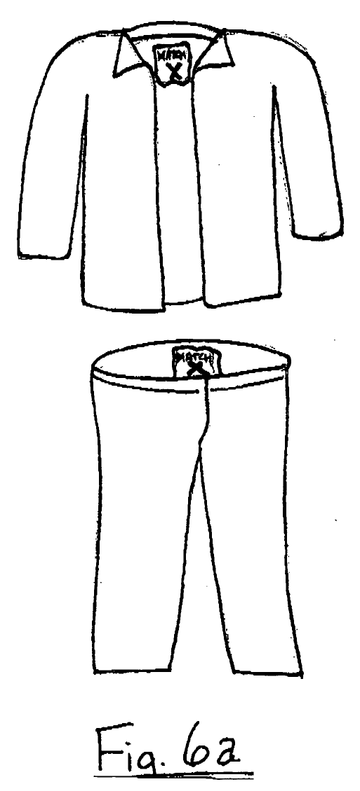

FIG. 6 depicts another embodiment of the present system, wherein a visual indicator on the substantially planar surface is used to properly coordinate articles of clothing. Here, the surface is of a generic shape and contains a symbol and text. However, the surface may be of any geometric shape and display any image, such as, but not limited to, animals, humans or other creatures, symbolic images, or text. The indicator may be made of a textile, polymer, or any other known or conveniently used material. It is affixed to an article of clothing by an adhesive, appliqué, hook-and-loop patch, thermosetting adhesive, thread, Velcro® or any other means known or convenient. It may also be affixed to any desired location on an article of clothing.

FIG. 6a depicts an embodiment of a visual indicator for properly coordinating articles of clothing in use in two pieces of clothing, a conventional shirt and pair of pants. In this embodiment, indicators displaying the same image or text are affixed to each article of clothing. The pieces of clothing would be of matching or complementary colors, styles, or patterns. When deciding on an ensemble, a person selects pieces having matching visual indicators, and thereby wears a coordinating outfit.

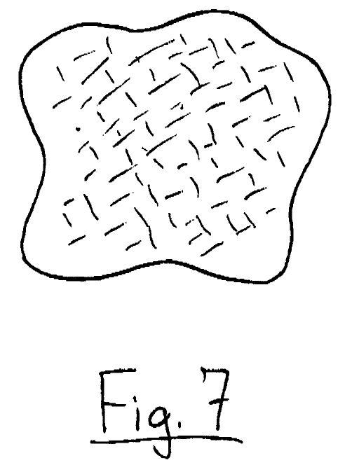

FIG. 7 depicts another embodiment of the present system, wherein a tactile indicator is used to properly coordinate articles of clothing. The indicator can be of any geometric shape have any known or convenient surface texture. It can even include text in Braille. This embodiment can be made of a textile, polymer, or any other known or conveniently used material. It is affixed to an article of clothing by an adhesive, appliqué, hook-and-loop patch, thermosetting adhesive, thread, Velcro® or any other means known or convenient. It can also be affixed to any desired location on an article of clothing.

This embodiment would be used in a similar manner as the visual indicators for properly coordinating articles of clothing. The indicators would be affixed to articles of clothing in the same manner as the visual indicators, with indicators of the same texture being affixed to articles of clothing having matching or complementary styles, patterns, or colors. In this embodiment, however, visually impaired persons could rely on their sense of touch, rather than visual images, to identify matching indicators. A visually impaired person could select coordinating ensembles by matching like tactile indicators.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A system to assist persons with properly orienting and coordinating clothing, comprising:
a set of markers, said set of markers comprising at least two substantially planar members, each of said substantially planar members being capable of being affixed to separate articles of clothing;
said substantially planar members in said set of markers having indicators corresponding to spatial orientations and aesthetic coordinations that can be matched to a user's body part or matched with other planar members in the same set of indicators that have been affixed to other articles of clothing, respectively.
